(19) United States
(12) Patent Application Publication
(10) Pub. No.: US 2004/0115597 A1
(43) Pub. Date: Jun. 17, 2004

(54) System and method of interactive learning using adaptive notes

(76) Inventor: Thomas Giles Butt, Langhorne, PA (US)

Correspondence Address: BRIGHTSPEED LEARNING INC., 14 PINE GLEN ROAD, LANGHORNE, PA, 19047, US

(21) Appl. No.: 10/724,953

(22) Filed: Dec. 1, 2003

Related U.S. Application Data
(60) Provisional application No. 60/432,596, filed on Dec. 11, 2002.

(51) Int. Cl. G09B 3/00; G09B 19/00

(52) U.S. Cl. 434/156; 434/323

(57) ABSTRACT

An educational software system is disclosed which includes interactive notes which automatically adapt to each student. Each note represents an individual item to learn and has an associated mastery level which is visually represented for the student. Built-in activities are provided which serve the dual purpose of providing practice and measurement in a multi-sensory, rapid response environment with immediate and specific feedback. The mastery level of each note is automatically adjusted by the student's performance. The software automatically selects notes to be practiced along with the activity to be used, thereby optimizing the student's practice time. The algorithm used for this selection takes into account such factors as the current mastery level of each note and the length of time since the note was last practiced.

This application claims the benefit of U.S. Provisional Application Serial No. 60/432,596, filed Dec. 11, 2002 and entitled “System and Method of Interactive Learning Using Adaptive Notes”, the specification and drawings of which are incorporated herein by reference in their entirety.

### BACKGROUND OF INVENTION

1. Field of the Invention

The present invention relates to a system and method of interactive learning using adaptive notes. More particularly, the present invention relates to educational software featuring interactive notes for use by students at all levels of instruction in a wide variety of subjects, which adapt to each individual student's current level of mastery.

2. Brief Background of the Invention

Education is one of the largest industries in the United States, second only to healthcare. As our economy becomes more knowledge-based, the need to train and retrain workers grows. But while the rest of the economy has seen astounding technological advances, education remains much as it has been for centuries. This is about to change. Technology offers the promise of substantial improvements in the administration, delivery, and execution of education in both corporate and academic settings. The paradigm of long lectures and tedious homework will give way to individualized mentoring, web-based courses, immersive multimedia practice, and online collaboration. Teachers will remain vital, but their role will evolve to accommodate newly emerging technologies.

In addition to technology, education is continually being influenced by ongoing research into the nature of learning. The process that any individual goes through to learn something new, and what it really means to know something is a complex subject that we continue to learn more about. Having said that, much of what is already widely accepted is not yet being applied for lack of training, exposure, cost, or perhaps motivation. There is a real opportunity to broaden the application of advanced learning techniques by incorporating them into widely distributed learning products.

While there are many theories regarding the best way to learn something new, nearly every approach involves at least two basic steps, presentation, and practice, or put another way, class work and homework. While most educators would agree that both elements are important to learning, most educational technology is currently focused on the presentation part. While this emphasis is perfectly understandable, it creates an opportunity for products and technology that deal more directly with the practice portion of the equation.

The present invention is designed to help students with the practice portion of their learning. It does this by providing learning materials which automatically track a student's demonstrated mastery and focus their attention where it is needed most.

### SUMMARY OF THE INVENTION

It is an object of the present invention to fulfill the foregoing and other needs of the prior art by the provision of software products in the form of interactive notes which automatically track and adapt to a student's current mastery level. Each note within each product represents an individual item to learn and is usually a small concept or fact. In the disclosed embodiment, for example, each note represents a single vocabulary word and its definition.

The software maintains a representation for each note of the student's current mastery level for that note. Notes must have two or more mastery levels, with each succeeding level representing a more complete mastery of the material. The mastery level of each note is visually shown to the student. The software also visually shows the student's mastery of the overall material. In the disclosed embodiment, for example, each note is represented by a dot whose color represents the note's mastery level and the overall mastery is represented by a vertical “progress” bar whose colored sections are sized proportional to the number of notes at the corresponding level of mastery.

The software also incorporates a series of built-in activities which serve the dual purpose of practice and measurement. The measurement is used to determine the student's mastery of each note and it's mastery level is automatically adjusted accordingly. The activities are designed to make the process of studying fast, fun, and effective. Each activity typically invokes multiple senses, requires relatively rapid responses from the student to enhance concentration, and provides immediate and specific feedback. Some activities may be more difficult than others, and are therefore only suitable for use once a note has already reached a specific mastery level. In addition, each activity may be designed to adapt it's difficulty level to the performance of the student.

In one aspect of the invention, the software automatically selects notes to be practiced along with the activity to be used, thereby automatically planning the student's practice time. The algorithm used for this selection takes into account such factors as the current mastery level of each note and the length of time since the note was last practiced. This mode allows the student to focus entirely on practicing the material to be learned.

### BRIEF DESCRIPTION OF THE DRAWINGS

For a more complete understanding of the present invention and the advantages thereof, reference may be made to the following description of exemplary embodiments thereof, taken in conjunction with the accompanying drawings, in which:

FIG. 1 shows the main screen of the exemplary embodiment;

FIG. 2 shows the first practice activity;

FIG. 3 shows the second practice activity;

FIG. 4 shows the third practice activity;

FIG. 5 shows a close up of an example note;

FIG. 6 shows an example note with multiple English translations;

FIG. 7 shows example notes with duplicate English phrases;

FIG. 8 shows an example set of notes for leaning U.S. States and Capitals; and

FIG. 9 shows an example set of notes for learning Multiplication.

### DESCRIPTION OF AN EXEMPLARY EMBODIMENT

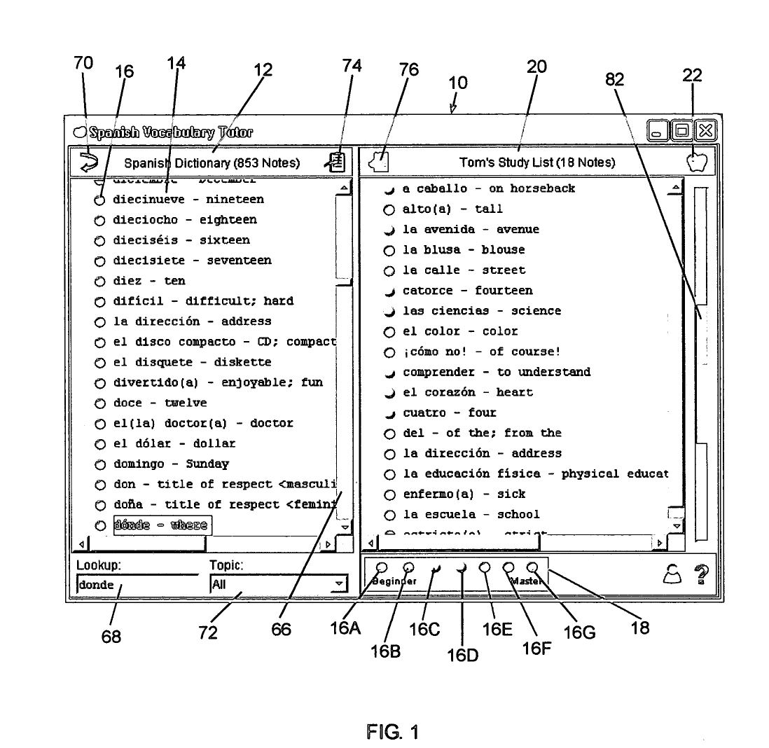

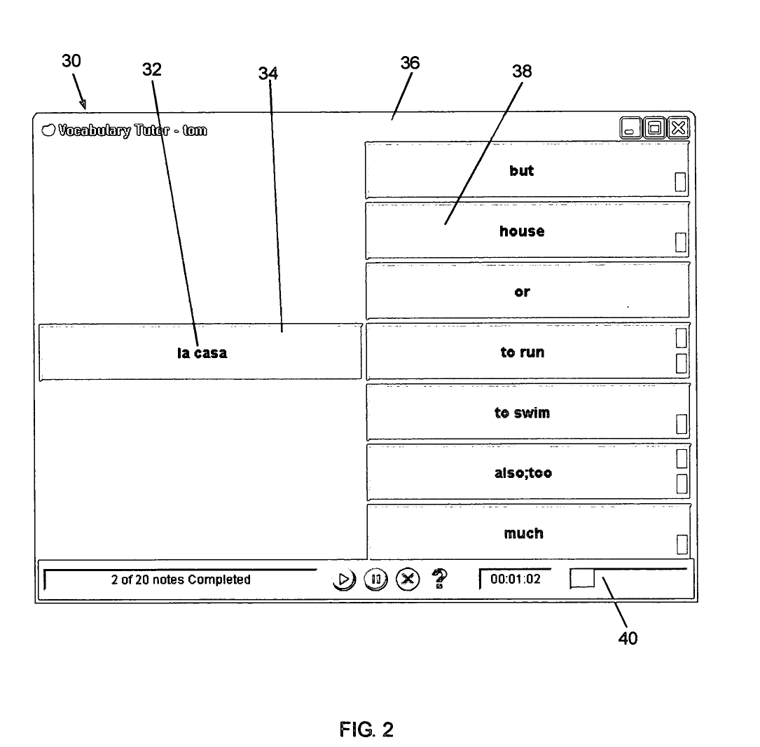

FIG. 1 depicts the main screen 10 of an exemplary embodiment of the invention, the Spanish Vocabulary Tutor. The left side of the screen contains a dictionary 12 of Spanish words and phrases along with their English translation. Each word or phrase represents an individual note 14 and includes a dot 16 whose color represents the student's mastery level for that note. A legend 18 near the bottom center of the screen 10 shows the various possible mastery levels in this embodiment. The right side of the screen contains those notes 14 which have been moved from the dictionary into this student's study list 20. The software will only provide practice activities for notes 14 that appear in this study list 20. This gives the student total control over the specific vocabulary he or she wishes to learn. Practice is initiated by pressing the apple button 22 in the upper right corner of the main screen 10. This will cause one of the activities, represented by FIGS. 2, 3, and 4, to be activated along with a selected subset of the notes 14 in the study list 20.

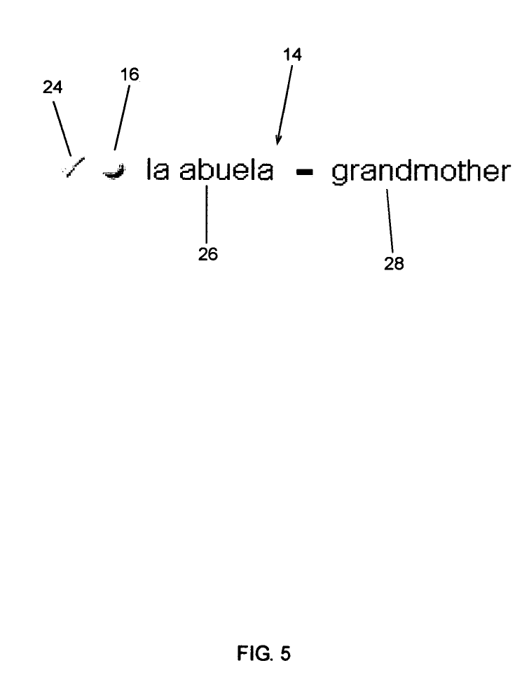

Central to the invention is the concept of an intelligent note. Each note 14 represents an individual item to learn. In the Spanish Vocabulary Tutor, each note 14 represents a Spanish word or phrase along with its English translation. FIG. 5 shows how one of these notes 14 might appear on the main screen 10.

The note 14 has a colored dot 16. The dot 16 tells the student at a glance how well he or she has mastered that note 14 so far. Although a colored dot 16 is used in this exemplary embodiment to represent this, any other visual clue would work just as well, including but not limited to shapes, shading, brightness, etc. As shown by the legend 18 at the bottom of the main screen in FIG. 1, the dot colors in the exemplary embodiment start with red and progress through the colors of the spectrum (red 16A, orange 16B, yellow 16C, green 16D, blue 16E, indigo 16F, and violet 16G) as the student improves.

The note 14 in FIG. 5 has a green checkmark 24 to the left of the dot 16. This indicates that the student was able to demonstrate a correct understanding of this note 14 the last time it was encountered in a practice activity. If the student had been incorrect, the green checkmark 24 would be replaced by a red X. These marks will only be visible for those notes 14 studied in the most recent practice activity.

The next thing each note 14 has is a visual representation of the information to be learned, in this case, the Spanish word 26 and its translation 28. Each note 14 typically also has some built-in behaviors to facilitate studying. In Spanish Vocabulary Tutor, double clicking on any note 14 causes a voiceover to be played which recites both the Spanish and English parts. This provides a clear sample of the proper pronunciation of the words.

Even in this exemplary embodiment, each note 14 maintains in addition to its mastery level, some other information such as the date it was last practiced, and whether it was marked correct or incorrect. More complex notes might also include information such as hints and related facts, images, movies or animations, 3D computer models, test questions, etc. Since the note 14 is an intelligent software object, it could include any data or behavior that is possible with software.

Although not incorporated in the exemplary embodiment, a simple note 14 might include a textual statement of fact and the activity's test questions. The note 14 may contain more than one test question and indicate that certain questions are only asked at certain mastery levels based on their difficulty. This most general form of note 14 could be easily applied to any topic. This would have the advantage of being relatively inexpensive to produce, but would not be quite as educationally effective as some of the more complex notes described here. For many topics, however, the minor gains achieved with custom notes, would not be worth the added complexity and cost.

While it is possible to study notes 14 manually, the Spanish Vocabulary Tutor has built-in activities designed to help the student learn more quickly and easily. Typically, several activities will be provided that get more challenging as the student learns. In this embodiment, there are three activities, each more challenging than the previous.

The first activity 30 is shown in FIG. 2. In this activity 30, there is a word or phrase 32 that appears in a block 34 on the left side of the first activity screen 36. Using the up and down arrow keys on the keyboard (not shown), the student moves this block up or down until it is next to the block 38 on the right that provides the correct translation and then hits the enter key on the keyboard. If the student gets it right, a voiceover is played providing further reinforcement; otherwise, a brief sound is played. Then a new word is selected for the left block 34 and the process repeats. The student must make a selection before the red bar timer 40 in the lower right corner expires. It should be obvious that the phrases in the blocks 34 correspond to the individual notes 14 from the main screen 10 shown in FIG. 1. When a user has matched a particular note 14 correctly three consecutive times, that note is considered “complete” for this activity 30 and that note is replaced with a new one. In the exemplary embodiment, this activity 30 normally starts with twenty notes 14 and is finished when all twenty notes have been “completed” successfully.

This particular activity 30 is designed for notes 14 the student is not yet familiar with. It drills the student in a relatively simple way until he or she demonstrates at least short term recall of the correct match. It helps the student to concentrate by forcing a guess within a relatively short period of time. It does this in a very non-threatening way since there is no real penalty for getting it wrong; the student just keeps trying until he or she gets it right. Also, the time is adjusted based on how the student is doing so it does not get too difficult or too easy. In general, activities are designed to make study time as effective as possible by applying the latest in learning theory.

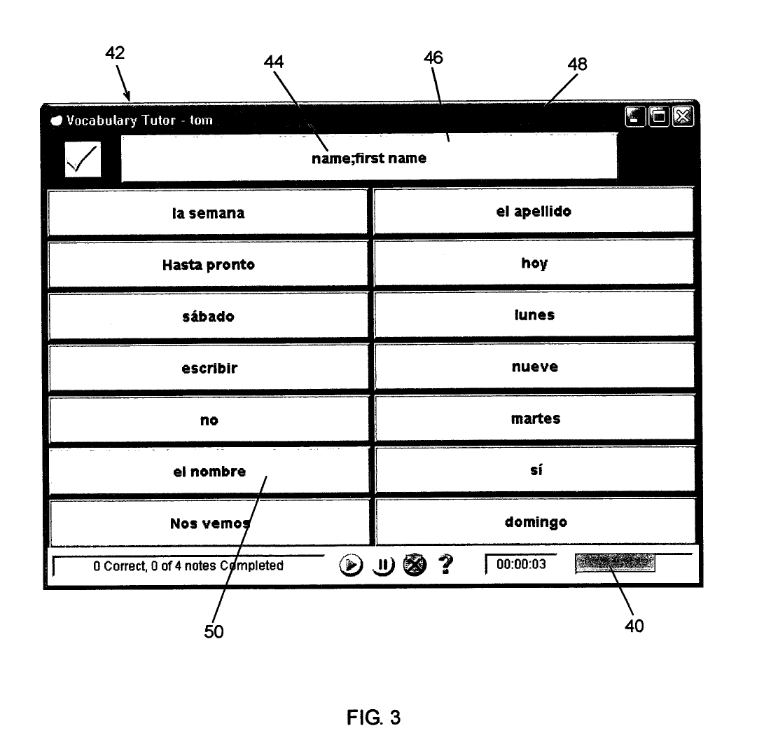

FIG. 3 shows a second activity 42 from the exemplary embodiment which provides an intermediate level of challenge. In this activity 42, a phrase 44 is shown in the block 46 at the top of the second activity screen 48 and the student must click on a choice 50 with the correct translation before the red bar timer 40 expires. The user only gets one chance at each note 14. Each click is followed by the correct match being highlighted and the voiceover played. Then the second activity 42 repeats the process for the next note 14. This continues until all the notes 14 in this batch are completed.

In this activity 42, each note 14 must be answered by the student either correctly or incorrectly. Also, this activity 42 is sometimes performed with the Spanish word in the block 46 at the top, and at other times performed with the English word in the block 46 at the top. This gets the student comfortable with recalling the correct meaning in both directions.

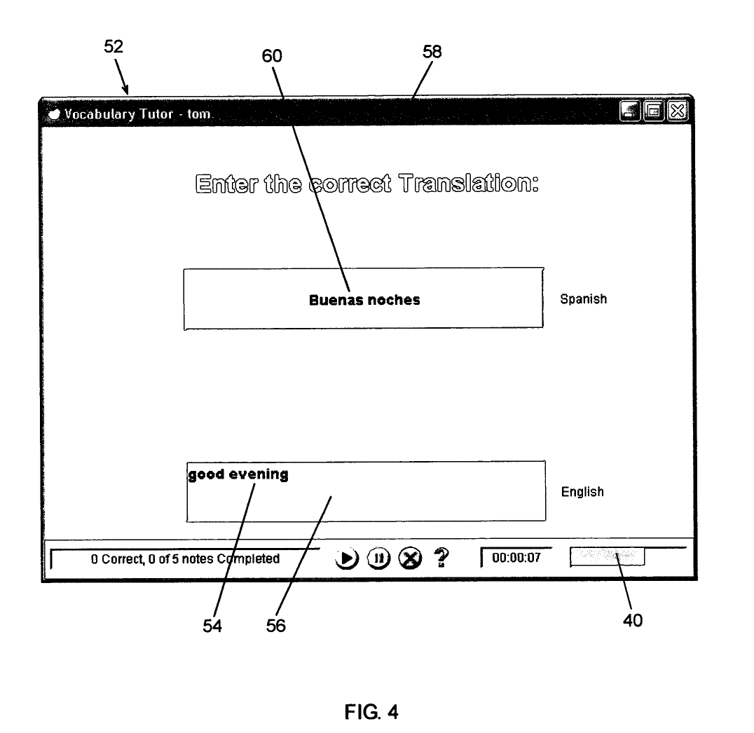

A third activity 52 in the exemplary embodiment is shown in FIG. 4. In this activity 52, the student is required to type in the correct translation 54 in a box 56 of the third activity screen 58 before the red bar timer 40 expires. After each answer, the correct answer is shown and a voiceover is played, and, as with the second activity 42, the student only gets one attempt at each note 14. Incorrect responses will cause the activity 52 to pause until the user corrects his or her translation 54. This ensures that the student gets practice typing the correct translation 54. As in the second activity 42, this activity 52 is sometimes performed with the Spanish word as the prompt, and sometimes with the English word as the prompt.

To keep this third activity 52 from being too difficult, the exemplary embodiment is designed to ignore upper and lower case, punctuation and leading and trailing spaces. By doing this, it is ensuring that the student can properly identify and spell the correct translation 54 without being overly picky about technicalities.

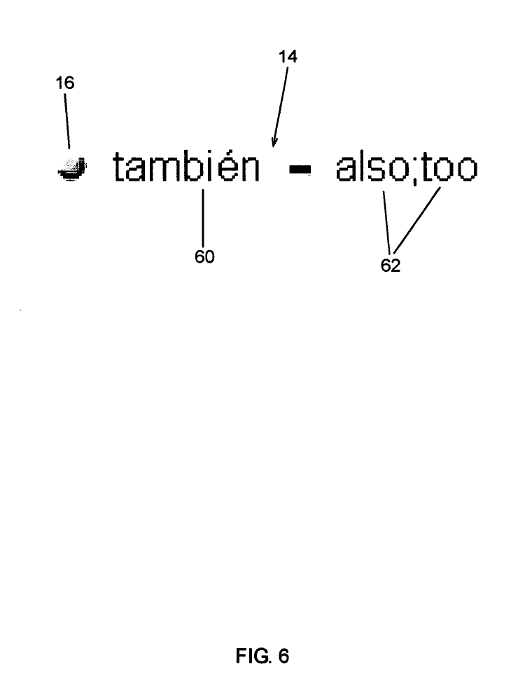

In Spanish, like in every other language, there is often more than one valid translation for any given word or phrase. The exemplary embodiment actually may handle this in one of several ways. If the Spanish phrase 60 has several English translations that are all synonyms 62, they are often listed in a single note 14 as shown in FIG. 6. In a case like this, the software will accept any of the English phrases listed as a correct translation 54. (The exemplary embodiment will likely never do this in reverse, namely list several Spanish phrases with one English phrase, since it is important that the student learns each Spanish word individually.)

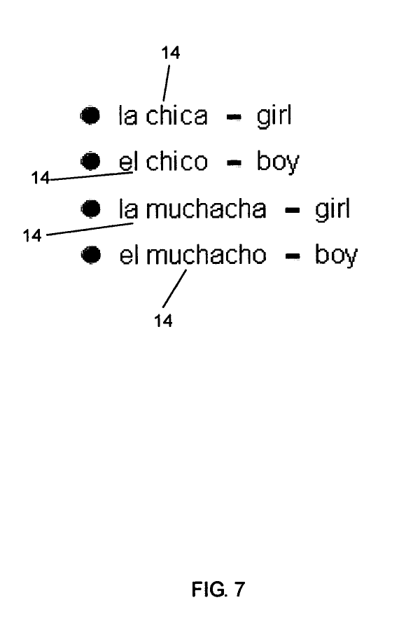

Another instance is when several different notes 14 have the same Spanish word 64. This is actually quite common. FIG. 7 lists several notes 14 from the exemplary embodiment that illustrate this. In this case, both boy and girl are listed with more than one Spanish word. If the word girl is shown and the user is asked to type or select a translation, the software may be expecting la muchacha or la chica. There is no way to tell. In this case, if the student enters a correct answer, but not the one currently being tested, he or she is asked to try an alternative term.

Each of the activities 30, 42, 52 described include a built-in timer 40, which limits the time a student has to respond. In each case, the time is adjusted to accommodate the particular student. In general, the time is set to challenge the student without being so fast as to cause frustration. In the case of the third activity 52, the timer 40 also takes into account how many letters the student must type.

Also, the student's performance in each activity 30, 42, 52 causes the mastery level of the notes 14 being studied to be adjusted. In general, a correct answer causes the mastery level of the corresponding note 14 to advance while an incorrect answer causes it to recede. The rate at which notes 14 advance and recede may also take into account factors such as how quickly the user answers and how he or she has performed in past activities.

Having intelligent notes 14 and fun activities to help a student study makes the Spanish Vocabulary Tutor a great way to learn. The software also determines automatically which notes 14 the student is to practice. Built into the exemplary embodiment is an intelligent algorithm that acts on the student's behalf to automatically determine what to do next. The primary objective of this algorithm is to help the student advance the mastery level of all the notes 14 in his or her study list 20 as quickly as possible.

Consider how a student with strong study skills might study Spanish vocabulary using flash cards. If there were too many cards to study at once, more than about twenty, the student would select a small group of cards to start with. First, the student would examine the front and back of each card trying to memorize the correct translation. Then, the student would look at each card, try to guess the correct translation, and then flip the card over to see if he or she got it right. If he or she gets it right a few times in a row, that card is set aside so the student can focus on the remaining cards. Once all the cards in the group can be answered correctly, the student would likely end this session and continue studying at a later time. When the student returned, say the next day, he or she would pick a new group of cards to study. But before doing that, the student would spend a few minutes reviewing the first group, being sure to spend extra time on the ones he or she gets wrong. As this process continued over many days, words from the first group may still be reviewed, although less frequently, with most of the time being spent on newer words that are not yet learned. Also, the student may give himself or herself more difficult challenges with words that the student is getting proficient with. For example, the student may try to spell the word correctly.

This brief example illustrates a number of important characteristics of effective studying: (1) the amount of material to study at one time should be manageable; (2) initial studying should continue until the student can demonstrate a reasonable level of understanding; (3) previously studied material should be reviewed at increasing intervals to encourage long-term retention; and (4) more difficult challenges should be applied as the student demonstrates mastery of the material.

In the exemplary embodiment, the software applies these and other principles to help optimize the student's study time. It does this by applying the following rules: (1) notes 14 that are at the red or orange level of mastery are practiced using the first activity 30 (FIG. 2); (2) notes 14 that are the yellow level of mastery are practiced using the second activity 42 (FIG. 3) with the English side of the note as the prompt; (3) notes 14 that are the green level of mastery are practiced using the second activity 42 (FIG. 3) with the Spanish side of the note as the prompt; (4) notes 14 that are the blue level of mastery are practiced using the third activity 52 (FIG. 4) with the English side of the note as the prompt; (5) notes 14 that are the indigo level of mastery are practiced using the third activity 52 (FIG. 4) with the Spanish side of the note as the prompt; (6) notes 14 that are the violet level of mastery are practiced using the third activity 52 (FIG. 4) with the prompt alternating between English and Spanish on subsequent invocations of the activity; (7) the first activity 30 will study a maximum of twenty notes 14 at a time while the other activities 42, 52 have no upper limit; (8) notes 14 that have already been practiced at least once will be reviewed at increasing intervals based on their mastery level; (9) notes 14 at higher levels of mastery which are due to be reviewed are given priority over notes at lower mastery levels i.e., old notes are reviewed before new notes are studied; and (10) when an activity 30, 42, 52 is started, all notes 14 which are currently due to be practiced using that activity are included up to the maximum allowed for that activity.

It is important to understand that the rules listed here are just an example that the exemplary embodiment uses. In general, there is no limit to the complexity of the rules that the software may apply. For example, each activity may include a number of settings (like the amount of time the student has to answer) that affect the difficulty level. The software may then modify these settings based on this student's performance.

Also, each activity 30, 42, 52 may include a number of preferences or properties that control the characteristics and behavior of that activity. Again, by learning what works best for this particular student over time, the software can choose the settings that maximize results. For example, one well respected learning theory is the so called Multiple Intelligences Theory pioneered by Harvard professor Howard Gardner. In this theory, Gardner proposed that an individual's level of intelligence is actually made up of autonomous faculties that can work individually or together. He originally identified seven such faculties which he called intelligences and has since added an eighth. They are Linguistic, Logical-Mathematical, Spatial, Musical, Bodily-Kinesthetic, Interpersonal, Intrapersonal, and Naturalist. Assuming that each activity stimulates each of these intelligences to different degrees, some activities will work better for some students than for others. The software can be designed to take that into account and plan accordingly.

In Spanish Vocabulary Tutor, notes 14 come in a dictionary 12 which provides several mechanisms to make it easier for the student to select the notes he or she wishes to study. By default, the notes 14 in the dictionary 12 are shown sorted alphabetically by their Spanish word. The student can quickly scroll to any word in the dictionary 12 by using the scroll bar 66, or by entering the first few letters in the lookup field 68 shown at the lower left of FIG. 1. By pressing the button 70 represented by the curved arrow at the top left of the main screen 10, the student can reverse the direction of the notes 14 to show the English on the left and the Spanish on the right. Doing this also causes the dictionary 12 to be resorted alphabetically by the English side.

Notes 14 can also be viewed based on topics by using the Topic menu 72 shown along the bottom of the main screen 10 in FIG. 1 just to the right of the lookup field 68. Selecting a topic from this menu 72 causes the dictionary display 12 to show only those notes 14 which are included in the selected topic.

Once the student has found the words in the dictionary 12 that he or she wants, the student moves them into the study list 20 by selecting them with a mouse (not shown) causing them to be highlighted and then clicking on the “add to study list” button 74. This button 74 is shown in FIG. 1 just above the top right corner of the dictionary 12. When this button 74 is clicked, all selected notes are moved into the student's study list 20. Conversely, a similar process is used to remove them. Clicking on the “remove from study list” button 76, shown in FIG. 1 just above the upper left corner of the study list 20, will remove any selected notes from this student's study list.

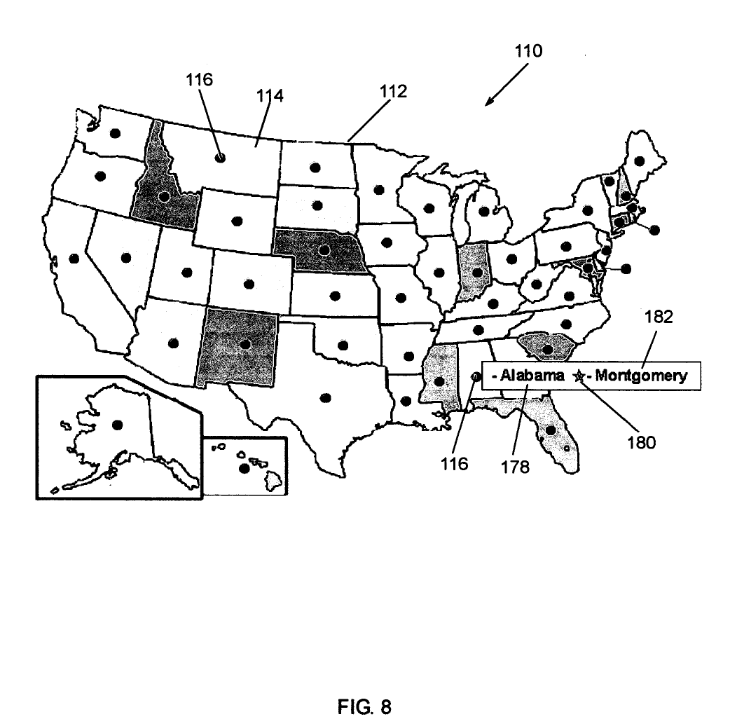

While the Spanish Vocabulary Tutor is an exemplary embodiment of the disclosed invention, it may be useful to briefly examine what some other embodiments may look like. FIG. 8 shows a set of example notes 114 for studying U.S. States and Capitals. Rather than showing the notes 14 in a list, the main screen 110 displays the notes 114 on a map 112. Clicking on the dot 116 causes the name 178 of the state to appear along with a star 180. The star 180 represents another note 114A that contains the name of the capital of the state. Clicking on the star 180 causes the name of the capital to appear 182. In this case, the color of the star 180 represents the user's mastery of the name of the capital for this particular state. Practice activities might include highlighting a state on the map 112 and having the user select the correct state name from a number of choices. The number of choices could be increased as the user's mastery improved. A similar activity might require the user to type in the correct state name. Similar activities could be provided where the user has to select or enter the name of the capital.

This example shows how a note 114 may include nested notes 114A, as in this case the capital note is nested within the state note. It is also possible to have more than one level of nesting, and more than one note 114A per level. This would allow much more complex information to be represented. This type of note 114A would work well for many geography topics where information must be related to its location on a map. It could also apply to things like identifying parts on a drawing, for example naming the bones on a skeleton.

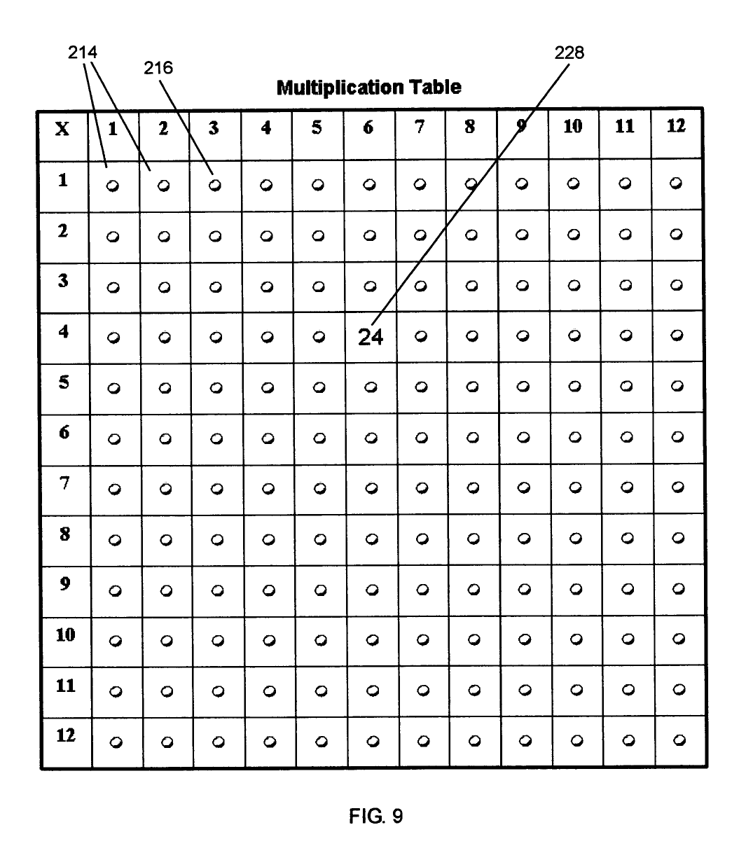

FIG. 9 shows a set of sample notes 214 for studying multiplication. In this case, each note 214 represents one of the multiplication problems for the numbers from 1 to 12. Clicking on the dot 216 causes the answer 228 to appear on top of the dot in the correct slot as shown for 4×6 in FIG. 9.

Activities for this example might include displaying a problem (e.g. 3×7=) and having the user select the correct answer from a number of choices. As the student develops mastery, the activity could increase the number of choices, and eventually require that the answer be typed in. Of course, the possibilities are endless. Notes could cover historical events placed along a timeline, or chemical elements shown in a periodic table.

Most of the capabilities described herein have been implemented in the exemplary embodiment. Additional features could be added. The exemplary embodiment included in the states and capitals example the ability to have nested notes 114A. This is a simple example of links between notes 114, 114A. Links could be used to refer the student to related information. Or, as another possibility, some notes 114 might have links to prerequisite notes whereby studying for a particular note would not begin until all notes that are specified as prerequisites have reached the specified mastery level.

Also, more sophisticated methods could be used to collect student input such as speech recognition or virtual reality systems. The study activities could get much more sophisticated incorporating the latest in 3D gaming. Also, new activities could be added to existing notes 14 on the fly. They could also incorporate scoring and perhaps have students compete for the highest score. Another feature would be the ability for a student to purchase new or add-on notes over the web directly from within his or her current copy of the software. Another alternative would allow the user to purchase a subscription where the new notes on a specific topic could be emailed or made available over the web at predefined intervals.

While the student can get a quick view of his or her current progress by viewing a progress bar 82 on the main screen 10, it may be helpful to add a more sophisticated progress report and perhaps even allow that report to be automatically sent to parents, teachers, or administrators. In a corporate setting, the report might go to management and include some security safeguards to prevent cheating. Finally, it could allow users to easily create their own notes which can be studied with the built-in activities.

Although the present invention has been described in detail, it should be understood that various changes, substitutions and alterations can be made hereto without departing from the spirit and scope of the invention. Accordingly, it is understood that the scope of the invention is to be limited only as set forth in the appended claims.

I claim:

1. Software embodied in a computer-readable medium and operable, when executed by a computer, to:
communicate to a user an activity containing information from a note for both teaching the user material in the note and measuring an understanding of the material in the note by the user;
receive a response to the activity from the user; and
determine from the response a measurement of the understanding of the material in the note by the user.

2. The software of claim 1 further operable to modify the activity based at least in part on at least one of the response and the measurement and further operable to communicate the modified activity to the user.

3. The software of claim 2 wherein the modification of the activity comprises communicating information from a second note to the user.

4. The software of claim 2 wherein the activity corresponds to a level of difficulty and the software is further operable to modify the level of difficulty of the activity based on the measurement.

5. The software of claim 1 wherein the software is operable to determine the time interval between communicating the activity to the user and receiving the response from the user and wherein the software is further operable to modify the activity based on the time interval.

6. The software of claim 1 further operable to communicate the measurement to the user.

7. The software of claim 6 further operable to communicate the measurement to the user visually.

8. The software of claim 7 further operable to communicate the measurement to the user continually.

9. The software of claim 1 further operable to communicate the activity to the user via a plurality of senses of the user.

10. The software of claim 1 further operable to select a new activity based at least in part on at least one of the response and the measurement.

11. The computer system according claim 1 wherein the software is operable to determine the time interval between communicating the activity to the user and receiving the response from the user and the software is further operable to select a new activity based at least in part on the time interval.

12. The software of claim 11 further operable to select the new activity based at least in part on the at least one of the response and the measurement.

13. The software of claim 12 further operable to select the new activity from a study list.

14. The software of claim 1 further operable to communicate the activity to the user from a study list.

15. The software of claim 14 wherein the study list comprises a plurality of notes.

16. The software of claim 15 wherein each of the plurality of notes is associated with at least one activity.

17. The software of claim 15 further operable to associate at least one of the plurality of notes with a visual clue indicative of a level of mastery of the note by the user.

18. The software of claim 17 further operable to select the visual clue based at least in part on the measurement.

19. The software of claim 18 further operable to select a new activity based at least in part on at least one of the response and the measurement.

20. The software of claim 19 wherein the software is operable to determine the time interval between communicating the activity to the user and receiving the response from the user and the software is further operable to select a new activity based at least in part on the time interval.

21. The software of claim 20 further operable to communicate the visual clue to the user as a color indicative of the level of mastery of the note by the user.

22. The software of claim 21 wherein the study list comprises a plurality of terms in a language to be learned.

23. The software of claim 17 further operable to communicate the visual clue to the user as a color indicative of the level of mastery of the note by the user.

24. The software of claim 15 further operable to communicate to the user, for at least one of the plurality of notes, information corresponding to the date the at least one of said plurality of notes was last communicated to the user.

25. The software of claim 15 further operable to communicate to the user for at least one of the plurality of notes information corresponding to the measurement of the response of the user when the at least one of said plurality of notes was last communicated to the user.

26. The software of claim 15 wherein at least one of the plurality of notes comprises a test question.

27. The software of claim 15 wherein at least one of the plurality of notes comprises a plurality of test questions.

28. The software of claim 27 wherein the measurement corresponds to a level of mastery by the user and the software is further operable not to communicate to the user at least one of the plurality of test questions unless the measurement exceeds a predetermined level of mastery by the user.

29. The software of claim 1 wherein the measurement corresponds to at least one level of mastery of the material by the user.

30. The software of claim 1 operable to receive the response by the user only within a predetermined time interval from the time the activity is communicated to the user.

31. The software of claim 1 further operable to select a new activity having a level of difficulty based at least in part on the measurement.

32. The software of claim 1 further operable to select a new activity having information from the note based at least in part on the measurement.

33. The software of claim 1 further operable to receive a plurality of responses from the user and to calculate a score based upon the responses of the user.

34. The software of claim 33 further operable to compare the score to a second score of a second user.

35. The software of claim 33 further operable to communicate the score to a person interested in the performance of the user.

36. The software of claim 35 wherein the person is an educator of the user.

37. The software of claim 35 wherein the person is a parent of the user.

38. The software of claim 35 wherein the person is the user.

39. The software of claim 1 further operable to receive a plurality of responses from the user and to generate a report based on the responses of the user.

40. The software of claim 39 further operable to communicate the report to a person interested in the performance of the user.

41. The software of claim 40 wherein the person is an educator of the user.

42. The software of claim 40 wherein the person is a parent of the user.

43. The software of claim 40 wherein the person is the user.

44. The software of claim 1 operable to receive the activity via the Internet.

45. The software of claim 1 operable to receive a plurality of activities and at least one of the plurality of activities is received by the software at a predetermined time interval from receipt of another one of the plurality of activities.

46. The software of claim 1 operable to receive the activity via the Internet based on a purchase by the user.

47. The software of claim 13 wherein the study list comprises a plurality of terms in a language to be learned.

48. The software of claim 47 wherein the activity comprises the user attempting to choose, from a plurality of possible answers, an answer that corresponds to the one of the plurality of terms being communicated to the user.

49. The software of claim 47 further operable to accept the answer only within a predetermined time interval from when the activity was communicated to the user.

50. The software of claim 47 further operable to determine the time interval between when the activity was communicated to the user and when the response by the user was received.

51. The software of claim 47 wherein the activity comprises the user attempting to communicate an answer that corresponds to the one of the plurality of terms communicated to the user.

52. The software of claim 15 wherein said plurality of notes includes at least one nested note.

53. The software of claim 1 wherein the activity includes a desired response and wherein the software is further operable to request an alternative response from the user if the response received from the user is correct but is not the desired response.

54. A method for teaching material in a note to a user and measuring the user's understanding of the material in the note comprising:
communicating an activity with information from a note to a user;
receiving a response to the activity from the user; and
determining from the response a measurement of the understanding of the material in the note by the user;
communicating to the user the measurement of the understanding of the material by the user; and
selecting a new activity to be communicated to the user based at least in part on the response.

55. A method for teaching material in a note to a user and measuring the user's understanding of the material in the note comprising:
communicating an activity with information from a note to a user;
receiving a response to the activity from the user; and
determining from the response a measurement of the understanding of the material in the note by the user;
communicating to the user the measurement of the understanding of the material by the user; and
modifying the activity by communicating information to the user from a second note selected at least in part based on the response.

56. A system for teaching material in a note to a user and measuring the user's understanding of the material in the note comprising:
means for communicating an activity with information from a note to a user;
means for receiving a response to the activity from the user; and
means for determining from the response a measurement of the understanding of the material in the note by the user;
means for communicating to the user the measurement of the understanding of the material by the user; and
means for selecting a new activity to be communicated to the user based at least in part on the response.

57. A system for teaching material in a note to a user and measuring the user's understanding of the material in the note comprising:
means for communicating an activity with information from a note to a user;
means for receiving a response to the activity from the user; and
means for determining from the response a measurement of the understanding of the material in the note by the user;
means for communicating to the user the measurement of the understanding of the material by the user; and
means for modifying the activity by communicating information to the user from a second note selected at least in part based on the response.
